(19) United States
(12) Patent Application Publication
(10) Pub. No.: US 2011/0233437 A1
(43) Pub. Date: Sep. 29, 2011

(54) VALVE

(75) Inventors: Noel Mattson, Winnipeg (CA); Arul Subramanian, Winnipeg (CA); Christopher Schwill, Winnipeg (CA)

(73) Assignee: Melet Plastics Inc., Winnipeg (CA)

(21) Appl. No.: 12/729,501

(22) Filed: Mar. 23, 2010

(51) Int. Cl. F16K 5/00

(52) U.S. Cl. 251/309

(57) ABSTRACT

A valve is provided having a flow passage interrupted by a plug chamber interposed in the flow passage. The plug chamber adapted to receive a rotatable valve plug inserted through the plug aperture and seated on the valve seat. The rotatable valve plug comprising a plug flow passage for fluid communication with the valve flow passage and extending through the plug and a pair of opposed resilient sealing region for the flow passage when the rotatable valve plug is oriented in a closed position. The sealing region presenting a leading edge at an obtuse leading edge angle relative to a portion of a wall of the plug chamber surrounding the flow passage, such that as the sealing region transitions into sealing engagement with the portion of the plug chamber wall as the rotatable valve plug is rotated from an open position to the closed position, the elastomeric seal is compressed substantially radially to form a seal against the plug chamber wall but not substantially deflected in a direction opposite to the direction of rotation. The sealing region presenting a trailing edge at an obtuse trailing edge angle relative to a portion of a wall of the plug chamber surrounding the flow passage, such that as the sealing region transitions into sealing engagement with the portion of the plug chamber wall as the rotatable valve plug is rotated from the closed position to the open position, the elastomeric seal is compressed substantially radially to form a seal against the plug chamber wall but not substantially deflected in a direction opposite to the direction of rotation.

### FIELD OF THE INVENTION

This invention relates to a valve. More particularly this invention relates to a valve seal.

### BACKGROUND OF THE INVENTION

Valves are used to control the flow of fluids. Low-cost valves may be assembled from parts comprised of injection-molded plastic. Generally, it has been difficult to create a plastic valve that is able to sustain relatively leak-free operation after repeated cycling between an open position and a closed position, or provide leak-free operation when closed and under pressure.

A standard valve usability test requires a valve to sustain relatively leak-free operation after cycling through repeated open-close cycles. In practice it has been difficult to manufacture plastic valves that can meet this standard.

There is a need for a valve that avoids the problems in the prior art. In particular, there is a need for a valve that may, in an embodiment, be manufactured substantially out of plastic. There is a need for a valve that can withstand repeated open-close cycles and maintain relatively leak-free operation. There is a need for a valve that provides unrestricted flow in an open position. There is also a need for a plastic valve that can withstand a pressure test in the open position with the outlet capped without leaking.

### BRIEF DESCRIPTION OF THE DRAWINGS

In drawings which illustrate by way of example only a preferred embodiment of the invention,

FIG. 1 is an isometric view of a valve.

FIG. 2 is an exploded view of the valve from FIG. 1 in a closed position.

FIG. 3A is a side view of a plug.

FIG. 3B is a cross-section view of the plug through Section 3B in FIG. 3A.

FIG. 3C is a close-up view of detail C from FIG. 3B.

FIG. 3D is a close-up view of the gasket from detail C at a point of first contact with a valve body flow passage wall.

FIG. 3E is a close-up view of the gasket from detail C engaged with a valve body flow passage wall.

FIG. 3F is a close-up view of an alternate profile gasket at a point of first contact with a valve body flow passage wall.

FIG. 3G is a close-up view of an alternate profile gasket engaged with a plug chamber wall.

FIG. 4A is a horizontal cross-section view of a valve body and valve plug in a closed position.

FIG. 4B is a horizontal cross-section view of a valve body and valve plug in a half-open position.

FIG. 4C is a horizontal cross-section view of a valve body and valve plug in an open position.

FIG. 5 is a vertical cross-section view of a valve body and valve plug in a closed position.

FIG. 6 is a vertical cross-section view of a valve body and valve plug in an open position.

FIG. 7A is a cross-section view of the gasket from detail C illustrating a gasket leading edge angle at a point of first contact with a valve body flow passage wall.

FIG. 7B is a cross-section view of an alternate gasket profile illustrating a gasket leading edge angle at a point of first contact with a valve body flow passage wall.

FIG. 7C is a cross-section view of the gasket from detail C illustrating a gasket trailing edge angle at a point of first contact with a valve body flow passage wall.

FIG. 7D is a cross-section view of an alternate gasket profile illustrating a gasket trailing edge angle at a point of first contact with a valve body flow passage wall.

### DETAILED DESCRIPTION OF THE INVENTION

In an embodiment a valve is provided having a valve body; said valve body defining an inlet aperture and an outlet aperture connected by a flow passage through said valve body, said flow passage interrupted between said inlet aperture and said outlet aperture by a plug chamber interposed in said flow passage, said flow passage defined at said plug chamber by a plug chamber inlet and a plug chamber outlet; said plug chamber terminated at one end by a valve seat and extending perpendicular to said flow passage to a plug aperture in said valve body, said valve seat and said plug aperture being located outside said flow passage; said plug chamber adapted to receive a rotatable valve plug inserted through said plug aperture and seated on said valve seat; a valve cap adapted to engage said valve body about said plug aperture to seal and retain said rotatable valve plug in said plug chamber; said rotatable valve plug comprising a plug flow passage for fluid communication with said valve flow passage and extending through said plug and a pair of opposed resilient sealing region for sealing around said plug chamber inlet and said plug chamber outlet when said rotatable valve plug is oriented in a closed position on said valve seat; said sealing region presenting a leading edge at an obtuse leading edge angle relative to a portion of a wall of said plug chamber surrounding said flow passage, such that as said sealing region transitions into sealing engagement with said portion of said plug chamber wall as said rotatable valve plug is rotated from an open position to said closed position on said valve seat, said elastomeric seal is compressed substantially radially to form a seal against said plug chamber wall but not substantially deflected in a direction opposite to said direction of rotation; and, said sealing region presenting a trailing edge at an obtuse trailing edge angle relative to a portion of a wall of said plug chamber surrounding said flow passage, such that as said sealing region transitions into sealing engagement with said portion of said plug chamber wall as said rotatable valve plug is rotated from said closed position to said open position on said valve seat, said elastomeric seal is compressed substantially radially to form a seal against said plug chamber wall but not substantially deflected in a direction opposite to said direction of rotation.

In an embodiment said valve body, said valve plug and said valve cap are comprised of injection molded plastic.

In an embodiment said sealing regions are comprised of a thermoplastic elastomer overmolded onto said valve plug.

In an embodiment said sealing regions in their uncompressed state have a profile of continuous convex shape.

In an embodiment said thermoplastic elastomer has a durometer between 45-60 Shore A.

In an embodiment said leading edge angle is greater than 150 degrees.

In an embodiment said trailing edge angle is greater than 150 degrees.

In an exemplar embodiment of a valve, a profile of said sealing regions extending beyond a valve plug exterior is approximately 0.070 inches in width and may extend a maximum of 0.010+/−0.002 inches beyond said valve plug exterior. Furthermore, said sealing regions may be compressed approximately 0.005 inches when fully engaged with said plug chamber wall. In this example, the distance between said plug chamber wall and said valve plug exterior may be about 0.005+/−0.002 inches when said valve plug is seated on said valve seat. When combined with the sealing region having a durometer between 45-60 Shore A, this example provides good sealing engagement with reasonable resistance to rotation.

In an embodiment of said valve, said sealing regions present a profile extending beyond said valve plug exterior a full width of exposed sealing region.

In an embodiment said sealing regions present a profile extending beyond said valve plug exterior a partial width of exposed sealing region. Optionally, said remaining width comprises a sealing region profile in line with said valve plug exterior.

In an embodiment of said valve, said valve body includes an inlet mating coupler comprising a ¾ NPT thread for coupling to a hot water tank and an outlet mating coupler comprising a garden house thread for coupling to a standard garden hose for tank drainage.

In an embodiment, said valve seat provides a bi-directional interface for limiting a rotation of said rotatable valve plug to 90° of rotation between said open position and said closed position.

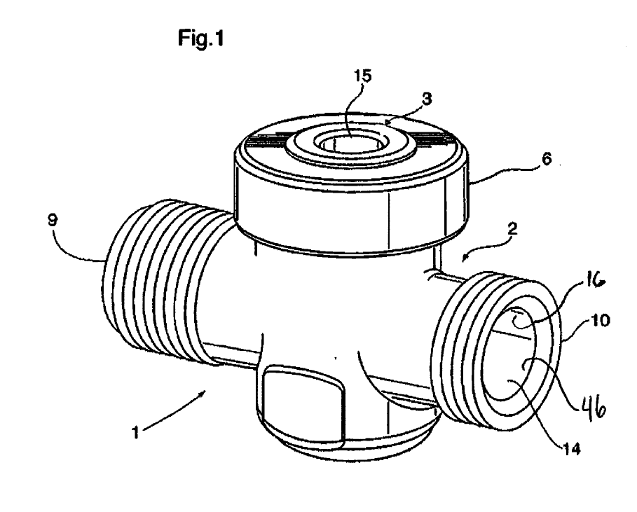

FIG. 1 is an isometric view of an embodiment of a valve 1. The valve 1 has a valve body 2, a rotatable valve plug 3, and a valve cap 6. The valve body 2 defines an inlet aperture, not shown in this view and an opposed outlet aperture 16. At the inlet aperture there is an inlet mating coupler 9 for mating with a fitting to supply a fluid to the inlet aperture. At the outlet aperture 16, there is an outlet mating coupler 10 for mating with a fitting to receive the fluid supplied from the inlet aperture. The fluid may flow from the inlet aperture to the outlet aperture 16 through a valve flow passage 14 extending through the valve body 2, a flow passage wall 46 observable through the outlet aperture 16. The valve plug 3 interrupts the flow passage 14 when in a closed position and preferably comprises a plug socket 15 for receiving a tool to engage the plug socket 15 to rotate the valve plug 3 between an open and a closed position in the valve body 2 on the valve seat of the valve body 2.

In the embodiment illustrated, the body 2 is a one piece design. The inlet mating coupler 9 in this embodiment incorporates a ¾ NPT thread for interface with a hot water tank (not shown). Outlet mating coupler 10 incorporates a garden house thread for interface with a standard garden hose for tank drainage. In this embodiment, the body 2 can be manufactured the inlet mating coupler 9 attached to different lengths of shaft to extend the inlet mating coupler 9 to accommodate hot water tanks of various styles.

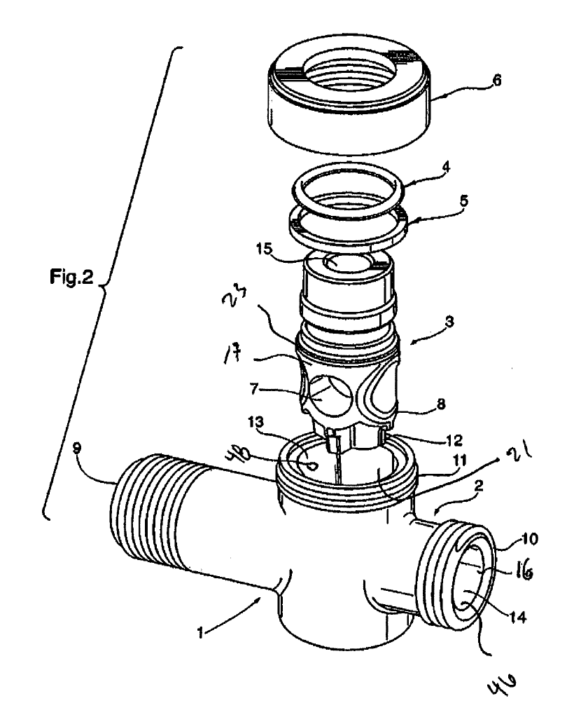

FIG. 2 is an isometric exploded view of the valve 1 of FIG. 1. In FIG. 2 an o-ring 4 and a washer 5 are included for sealing the cap 6 plug 3 and body 2 interface. As will be appreciated, other means of sealing may be used, though an o-ring 4 and a washer 5 are typical.

In a preferred embodiment, the body 2, plug 3, washer 5 and cap 6 are all made using injection molded plastic material. In the embodiment of FIG. 2, the washer 5 is a flat disc of plastic that provides a surface to surface seal between the body 2 and the washer 5. The washer 5 also seals the plug 3 in the body 2, when the cap 6 is coupled onto the body 2, compressing the O-ring 4 placed between the cap 6, washer 5 and plug 3.

The sealing region 8 is preferably an overmolded thermoplastic elastomer. In a preferred embodiment the thermoplastic elastomer has a durometer between 45-60 Shore A. The o-ring 4 is typically an elastomer or rubber that allows for compressive deformation to provide sealing. In this embodiment, the o-ring 4 is made of EPDM.

The flow passage 14, defined by flow passage wall 46, is interrupted between the inlet aperture and the outlet aperture 16 by a plug chamber 13 interposed the flow passage 14. The flow passage 14 is defined at the plug chamber 13 by a plug chamber inlet and a plug chamber outlet (not shown in FIG. 2).

The plug chamber 13, defined by plug chamber wall 48, is terminated at one end by a valve seat (not shown in FIG. 2) and extending perpendicular to the flow passage 14 to terminate at a plug aperture 21 in the valve body 2. The valve seat and the plug aperture 21 are located outside the flow passage 14 to bound the plug chamber 13 and the plug 3, when seated on the valve seat.

The plug chamber 13 is adapted to receive the rotatable valve plug 3 by inserting the plug 3 through plug aperture 21 and seating the plug 3 on the valve seat. The mating coupler 11 near the plug aperture 21 couples with the cap 6. The valve cap 6 may be coupled to the valve body 2 over the plug aperture 21 and plug 3, when seated, to retain the plug 3 in the plug chamber 13. The valve cap 6 provides both mechanical retention of the plug 3, as well as sealing engagement at the plug 3, valve body 2 and cap 6 interface. In a preferred arrangement, the sealing engagement is provided by the gasket 5 and o-ring 4 illustrated in FIG. 2.

The plug 3 includes a plug flow passage 7 that may be aligned with the plug chamber inlet and the plug chamber outlet when the plug 3 is seated on the valve seat and rotated to an open position. In the open position, the plug 3 continues the flow passage 14 to allow for fluid communication between the inlet and the outlet apertures 16.

The plug 3 also includes opposed sealing regions 8 for sealing around the plug chamber inlet and the plug chamber outlet when the plug 3 is seated on the valve seat and rotated to a closed position. The sealing regions 8 are preferably formed from a thermoplastic elastomer overmolded onto the plug 3. In an embodiment the sealing regions 8 may extend as a circumferential sealing 23 around a circumference of the plug 3 between the plug flow passage 7 and the plug aperture 21 to provide sealing engagement between the plug chamber wall 48 and the plug 3 to prevent fluid from escaping from the valve 1. In a preferred embodiment, the sealing regions 8 comprise a continuous elastomer overmolding to form both the sealing regions 8 and the circumferential sealing 23.

The sealing regions 8 may be described as having a “leading edge” and a “trailing edge”. The terms leading edge and trailing edge are relative, but in the context of this application are being used to describe the edge of the region 8 that first contacts the flow passage wall 46 when the plug 3 is rotated to an open position, the leading edge, and to a closed position, the trailing edge.

As will be appreciated one of the sealing regions 8 seals around the plug chamber inlet and the other of the sealing regions 8 seals around the plug chamber outlet. As the plug 3 is rotated from an open position to a closed position, the leading edge of each of the sealing regions 8 will be relocated from engagement with the plug chamber wall 48, into either the plug chamber inlet or the plug chamber outlet, before initiating contact with the flow passage wall 46 before completing the rotation to the closed position with sealing engagement against the plug chamber wall 48.

When the plug 3 is rotated from the closed position to the open position, the trailing edge relocates from sealing engagement with the plug chamber wall 48, into either the plug chamber inlet or the plug chamber outlet, before initiating contact with the flow passage wall 46 before completing the rotation to the open position with sealing engagement against the plug chamber wall 48.

Since the plug 3 is preferably constrained to 90° of rotation between the open and closed positions, half of each sealing region 8 transitions from engagement to sealing engagement while passing past the plug chamber inlet or plug chamber outlet, while the other half of each sealing region 8 transitions from engagement to sealing engagement while facing only the plug chamber wall 48. The other half thus does not engage the flow passage wall 46 when the plug 3 is rotated.

Thus, the terms leading edge and trailing edge refers to the inside edge and the outside edge of the half of each sealing region 8 that passes past either the plug chamber inlet or the plug chamber outlet. While in practice the profile of the sealing region 8 may be consistent around its entire circumference, only the portion that engages the flow passage wall 14 requires the specific leading edge and trailing edge profiles.

Preferably, the sealing regions 8 presenting a leading edge at a leading edge angle of greater than about 130 degrees from the leading edge of the sealing region to a portion of the plug chamber wall 48 adjacent to the flow passage wall 46 when the sealing region 8 passes past either the plug chamber inlet or the plug chamber outlet to sealing engagement with the plug chamber wall 48.

In the embodiment of FIG. 2, the plug 3 is a tapered plug and the plug chamber 13 is slightly tapered to match the plug 3. The plug 3 includes a bi-directional interface 12 for engagement with projections from the valve seat to limit the plug 3 to 90° of rotation, between an open position and a closed position.

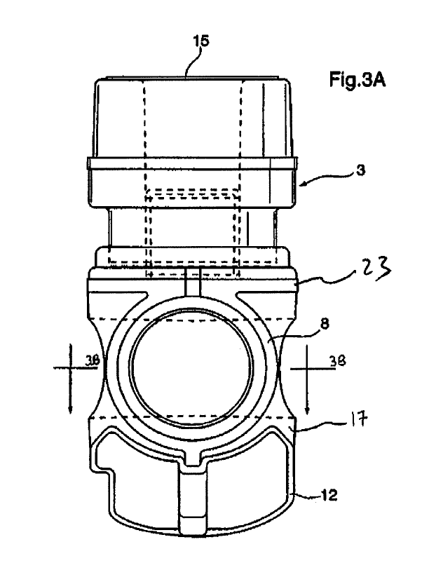

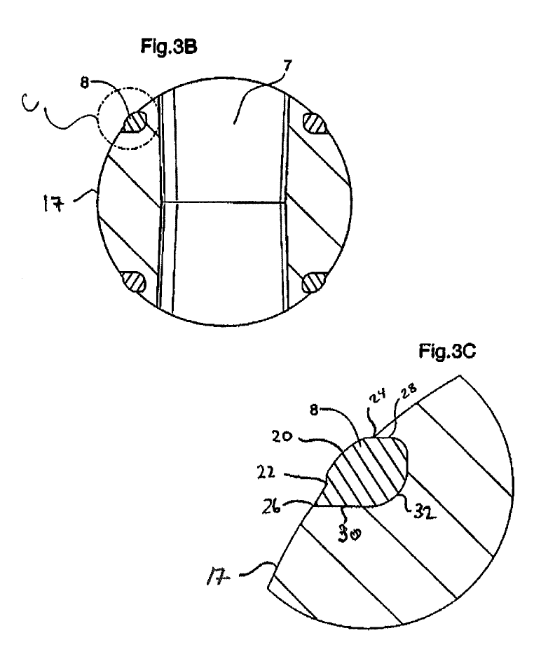

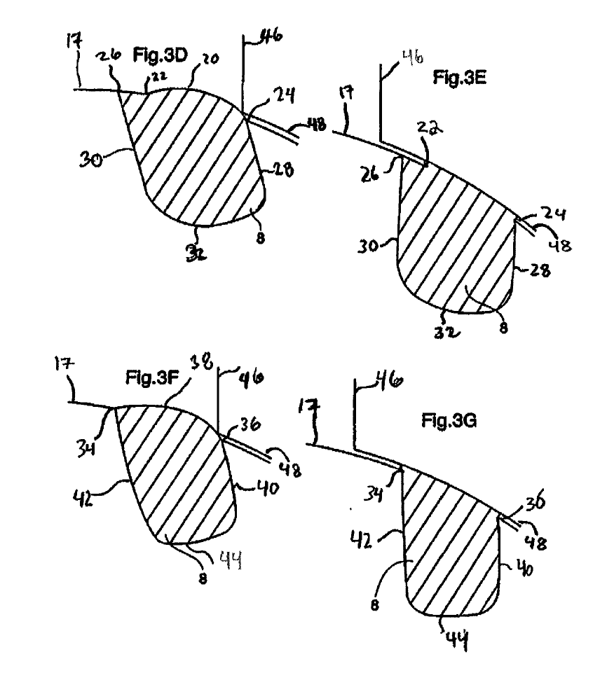

FIG. 3A is side view of the plug 3 facing a sealing region 8. FIG. 3B is a horizontal section view taken through section 3B identified in FIG. 3A. FIG. 3B identifies Detail C, illustrated in FIG. 3C, a close-up view of the profile of this embodiment of the sealing region 8. For the purposes of illustration, Detail C is taken to be the portion of the sealing region 8 that passes past either the plug chamber inlet or the plug chamber outlet when the plug 3 is rotated.

Referring to FIG. 3C, sealing region 8 has a leading edge wall 28 which meets the plug surface 17 at a leading edge protrusion point 24. The sealing region 8 also has a trailing edge wall 30 which meets the plug surface 17 at a trailing edge point 26. The sealing region 8 protrudes from the plug surface 17 from the leading edge protrusion point 24 to a trailing edge protrusion point 22. In the embodiment of the sealing region 8 profile illustrated in FIG. 3C, the trailing edge protrusion point 22 is offset from the trailing edge point 26. A similar offset could be provided at the leading edge. In an alternate embodiment, the trailing edge protrusion point meets the trailing edge point 26, similar to the arrangement for the leading edge protrusion point 24 in FIG. 3C. The sealing regions 8 extend into the plug 3 from the plug surface 17 to a region of maximum depth 32.

In an exemplar embodiment, the distance between the leading edge protrusion point 24 and the non-leading edge protrusion point 22 is about 0.070+/−0.002 inches and in their uncompressed state, the sealing regions 8 protrude about 0.010+/−0.002 inches from the plug surface 17 at a region of maximum protrusion 20. In this embodiment the clearance between the plug chamber wall 48 and the plug surface 17 when the plug 3 is seated, may be about 0.005+/−0.002 inches. Accordingly, the sealing regions 8 may be compressed about 0.005 inches when in sealing engagement. In this case, a distance between the plug chamber wall and the valve plug exterior is about 50+/−20% of the height of the uncompressed sealing regions when the valve plug is seated on said valve seat. Thus, the height of the sealing regions extending beyond the exterior of the plug is compressed approximately 50% when fully engaged with the plug chamber wall.

In this exemplar embodiment, a cross-sectional profile of said sealing regions extending beyond an exterior of said valve plug body has a width to height ratio of about 0.070+/−0.002 inches to 0.010+/−0.002 inches or between approximately 7.2:0.8 and 6.8:1.2.

The profile of the sealing regions 8 in their uncompressed state may present a generally continuous convex curve with a peak at the region of maximum protrusion 20. Alternatively, the profile may comprise a leading edge having a leading edge angle and a trailing edge having a trailing edge angle and a flat plateau portion separating the leading edge and the trailing edge. In this embodiment the plateau may have a consistent extent of protrusion across its length, as opposed to the curve which provides a peak of maximum protrusion 20.

In general, the sealing regions 8 have an increased sealing area with a smaller amount of compression than prior art sealing means, such as an O-Ring. The obtuse leading edge angle θ and trailing edge angle φ provide less resistance and wear when the sealing regions 8 engage the flow passage wall 46.

FIGS. 3D and 3E illustrate an embodiment of the sealing regions 8 transitioning from first contact with the flow passage wall 46 to sealing engagement with plug chamber wall 48.

FIGS. 3F and 3G, illustrate an alternate embodiment of sealing regions 8 transitioning from first contact with the flow passage wall 46 to sealing engagement with plug chamber wall 48. The sealing regions 8 protrude from the plug surface 17 from an alternate leading edge protrusion point 36 to an alternate trailing edge protrusion point 34. The sealing regions 8 have an alternate leading edge wall 40 which meets the plug surface 17 at the alternate leading edge protrusion point 36. The gaskets 8 also have an alternate trailing edge wall 42 which meets the plug surface 17 at an alternate trailing edge protrusion point 34. The sealing regions 8 extend from the plug surface 17 to an alternate region of maximum depth 44. With reference to the exemplar embodiment, the distance between the alternate leading edge protrusion point 36 and the alternate non-leading edge protrusion point 34 could be about 0.070 inches. In this example, in their uncompressed state, the sealing regions 8 could protrude about 0.010+/−0.002 inches from the plug surface 17 to an alternate region of maximum protrusion 38.

The size and exact dimensions of the sealing regions 8 depend on several factors, including the overmolding process and the minimum amount of material needed to provide certain desired properties. The Figures are drawn not to scale to provide sufficient difference in dimension for illustrative purposes. If the Figures were drawn to scale, the clearance between the plug and the chamber wall, and the protrusion of the sealing region would be too small to assess in these drawings. Thus, the dimensions in the embodiment of FIGS. 3B, 3C, 3D and 3E are not to scale with the dimensions in the embodiment of FIGS. 3F and 3G.

Further, the size of the section of the sealing regions 8 which protrudes from the plug surface 17 is independent of the size of the section of the sealing regions 8 which does not protrude from the plug surface 17.

While not to scale, the close-up profiles of the sealing region are reasonably accurate to the exemplar embodiment and dimensions provided.

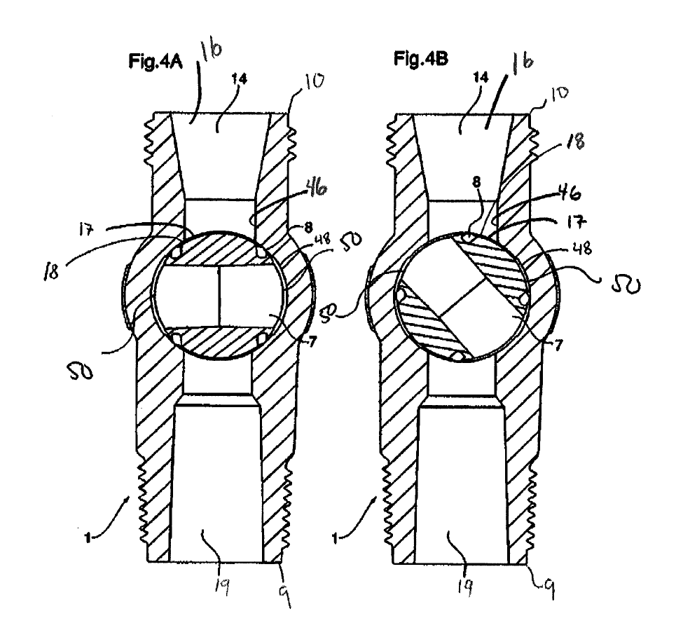

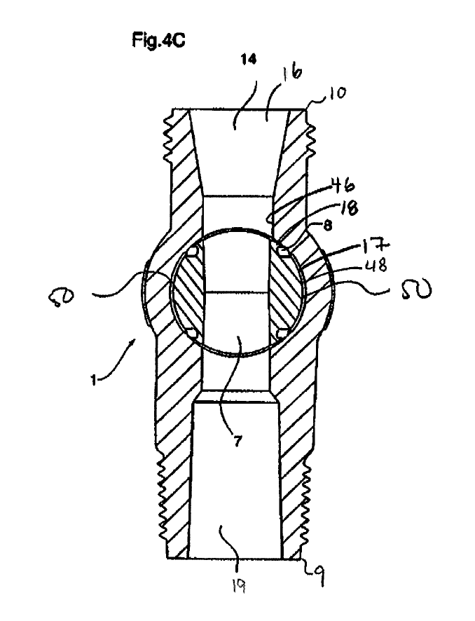

FIGS. 4A, 4B and 4C, illustrate the plug 3 transitioning from a closed position in FIG. 4A to an open position in FIG. 4C. In FIGS. 4A, 4B and 4C, the valve body 2 defines an inlet aperture 19 and the opposed outlet aperture 16. In FIG. 4A, the plug 3 has an exposed plug surface 18 which is the portion of the plug 3 which is exposed to the plug chamber outlet during opening and closing. As illustrated in the Figures, the plug chamber 13 may comprise a cavity 50 to provide clearance between the plug chamber wall 48 and the plug surface 17. Preferably cavity 50 includes sloped transition surfaces to provide a smooth transition from the plug chamber wall 48 providing a plug sealing surface to the cavity portion. Cavity 50 allows for reduced wear of the plug 3 and sealing regions 8.

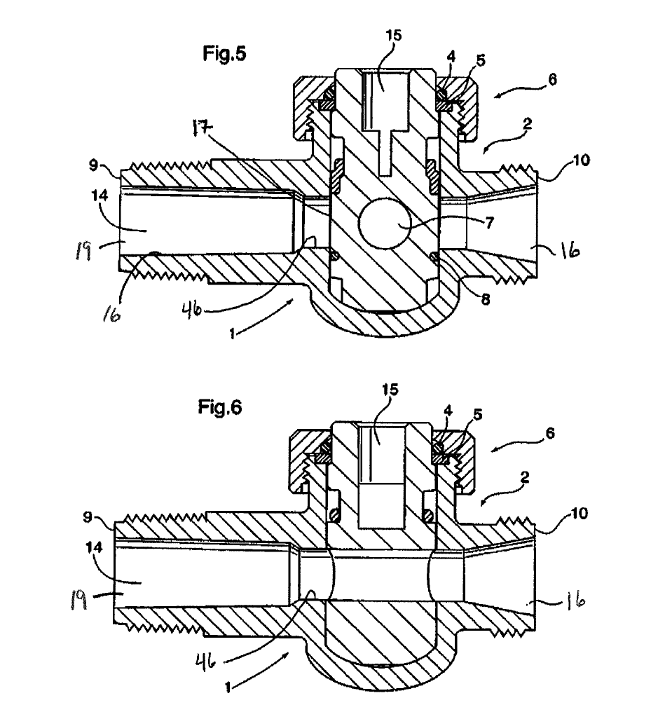

FIGS. 5 and 6 are vertical cross-section views of the valve 1 when fully assembled. FIG. 5 illustrates the valve 1 with the plug 3 in a closed position and FIG. 6 illustrates the valve 1 with the plug 3 in an open position.

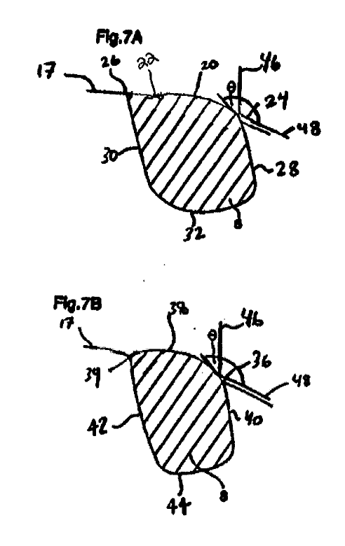

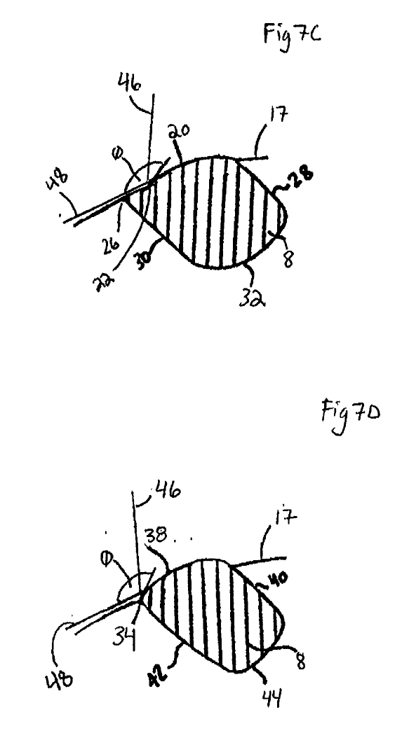

FIGS. 7A, 7B, 7C and 7D illustrate the leading edge angle and the trailing edge angle as θ and φ for two exemplary embodiments of sealing region profiles. In FIGS. 7A and 7C, the sealing region 8 has a profile with a flat portion in-line with the exterior of the plug 3 and a raised portion that comprises the compressible portion of the sealing region 8 that engages with plug chamber wall 48. With reference to FIG. 7A, preferably angle θ may be between about 140 degrees and 160 degrees to minimise sealing region 8 wear through repeated open-close cycles. A preferred arrangement provides angle θ at about 150 degrees to balance minimising wear with the width of the sealing region required to reach a desired maximum protrusion from the plug surface 17.

With reference to FIG. 7C, preferably angle φ may be between about 140 degrees and 160 degrees to minimise sealing region 8 wear through repeated open-close cycles. A preferred arrangement provides angle φ at about 150 degrees to balance minimising wear with the width of the sealing region 8 required to reach a desired maximum protrusion from the plug surface 17.

It will be appreciated from FIGS. 3D, 3E, 3F and 3G that the amount of compression of sealing region 8 when in the sealing engagement affects the rotational resistance. Accordingly, the compression of sealing region 8 during sealing engagement provides a sufficient pressure to provide sealing engagement between the sealing region 8 and the plug chamber wall 48, yet creates a minimal amount of rotational resistance when the valve plug 3 is rotated between the open and closed position in the valve body 2.

It will further be appreciated that leak-free sealing is achieved in the present invention by the combination of all the features of the invention, and not solely by the operation of any one feature.

Various embodiments of the present invention having been thus described in detail by way of example, it will be apparent to those skilled in the art that variations and modifications may be made without departing from the invention. The invention includes all such variations and modifications as fall within the scope of the appended claims.

1. A valve comprising:
a valve body;
said valve body defining an inlet aperture and an outlet aperture connected by a flow passage through said valve body, said flow passage interrupted between said inlet aperture and said outlet aperture by a plug chamber interposed in said flow passage, said flow passage defined at said plug chamber by a plug chamber inlet and a plug chamber outlet;
said plug chamber terminated at one end by a valve seat and extending perpendicular to said flow passage to a plug aperture in said valve body, said valve seat and said plug aperture being located outside said flow passage;
said plug chamber adapted to receive a rotatable valve plug inserted through said plug aperture and seated on said valve seat;
a valve cap adapted to engage said valve body about said plug aperture to seal and retain said rotatable valve plug in said plug chamber;
said rotatable valve plug comprising a plug flow passage for fluid communication with said valve flow passage and extending through said plug and a pair of opposed resilient sealing region for sealing around said plug chamber inlet and said plug chamber outlet when said rotatable valve plug is oriented in a closed position on said valve seat;
said sealing region presenting a leading edge at an obtuse leading edge angle relative to a portion of a wall of said plug chamber surrounding said flow passage, such that as said sealing region transitions into sealing engagement with said portion of said plug chamber wall as said rotatable valve plug is rotated from an open position to said closed position on said valve seat, said elastomeric seal is compressed substantially radially to form a seal against said plug chamber wall but not substantially deflected in a direction opposite to said direction of rotation; and,
said sealing region presenting a trailing edge at an obtuse trailing edge angle relative to a portion of a wall of said plug chamber surrounding said flow passage, such that as said sealing region transitions into sealing engagement with said portion of said plug chamber wall as said rotatable valve plug is rotated from said closed position to said open position on said valve seat, said elastomeric seal is compressed substantially radially to form a seal against said plug chamber wall but not substantially deflected in a direction opposite to said direction of rotation.

2. The valve of claim 1 wherein said valve body, said valve plug and said valve cap are comprised of injection molded plastic.

3. The valve of claim 1 wherein said sealing regions are comprised of a thermoplastic elastomer overmolded onto said valve plug.

4. The valve of claim 1 wherein the sealing regions in their uncompressed state have a profile of continuous convex shape.

5. The valve of claim 2 wherein said thermoplastic elastomer has a durometer between 45-60 Shore A.

6. The valve of claim 1 wherein said leading edge angle is greater than 130 degrees.

7. The valve of claim 1 wherein said trailing edge angle is greater than 130 degrees.

8. The valve of claim 1 wherein said leading edge angle is about 150 degrees.

9. The valve of claim 1 wherein said trailing edge angle is about 150 degrees.

10. The valve of claim 1 wherein said sealing regions present a profile extending beyond said valve plug exterior a full width of exposed sealing region.

11. The valve of claim 1 wherein said sealing regions present a profile extending beyond said valve plug exterior a partial width of exposed sealing region.

12. The valve of claim 11 wherein said remaining width comprises a sealing region profile in line with said valve plug exterior.

13. The valve of claim 1 wherein said valve body includes an inlet mating coupler comprising a ¾ NPT thread for coupling to a hot water tank and an outlet mating coupler comprising a garden house thread for coupling to a standard garden hose for tank drainage.

14. The valve of claim 1 wherein said valve seat provides a a bi-directional interface for limiting a rotation of said rotatable valve plug to 90° of rotation between said open position and said closed position.
